(19) United States
(12) Patent Application Publication
(10) Pub. No.: US 2008/0091853 A1
(43) Pub. Date: Apr. 17, 2008

(54) Controlling Circuit Throughput

(75) Inventor: Michael Dolle, Grasbrunn (DE)

Correspondence Address: BANNER & WITCOFF, LTD.;Attorneys for client 007052, 1100 13th STREET, N.W., SUITE 1200, WASHINGTON, DC, 20005-4051, US

(73) Assignee: INFINEON TECHNOLOGIES AG, Neubiberg (DE)

(21) Appl. No.: 11/869,831

(22) Filed: Oct. 10, 2007

(30) Foreign Application Priority Data
Oct. 12, 2006 (DE) 102006048379.0

(51) Int. Cl. G06F 3/00

(52) U.S. Cl. 710/29

(57) ABSTRACT

Methods and apparatuses in which a throughput of a circuit is determined, the throughput is compared to a predetermined value; and the circuit is controlled so as to adjust the throughput in a manner that depends upon an outcome of the comparison.

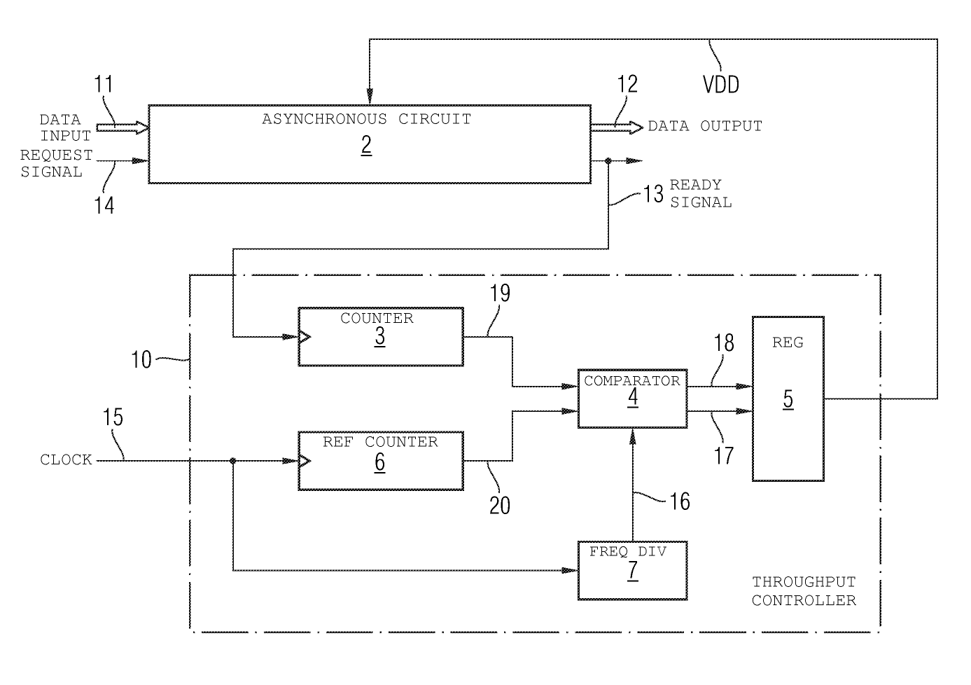

### CROSS-REFERENCE TO RELATED APPLICATIONS

The present application claims priority to German patent application no. DE 10 2006 048 379.0, filed Oct. 12, 2006, hereby incorporated by reference as to its entirety.

### BACKGROUND

While power consumption is a relevant factor in all electronic equipment, it is of particular importance with regard to portable electronic devices, such as mobile phones, personal digital assistants (PDAs), and laptop computers. One factor affecting power consumption of an electronic device is the throughput of the electronic device. The throughput of a device may refer to, for example, the number of operations per unit of time that the electronic circuit completes or executes. It is generally true that the power consumption of an electronic circuit increases with the throughput of the electronic circuit. In other words: the power consumption of an electronic circuit may be controlled by controlling the throughput of the electronic circuit.

### SUMMARY

Various methods and apparatuses are described, in which a throughput of a circuit is determined, the throughput is compared to a predetermined value; and the circuit is controlled so as to adjust the throughput in a manner that depends upon an outcome of the comparison.

These and other aspects of the disclosure will be apparent upon consideration of the following detailed description of illustrative aspects.

### BRIEF DESCRIPTION OF THE DRAWINGS

A more complete understanding of the present disclosure may be acquired by referring to the following description in consideration of the accompanying drawings, in which like reference numbers indicate like features, and wherein the single figure is a functional block diagram of an illustrative embodiment of a semiconductor circuit with a throughput controller.

### DETAILED DESCRIPTION

The various aspects summarized previously may be embodied in various forms. The following description shows by way of illustration various examples in which the aspects may be practiced. It is understood that other examples may be utilized, and that structural and functional modifications may be made, without departing from the scope of the present disclosure.

Except where explicitly stated otherwise, all references herein to two or more elements being “coupled,” “connected,” and “interconnected” to each other is intended to broadly include both (a) the elements being directly connected to each other, or otherwise in direct communication with each other, without any intervening elements, as well as (b) the elements being indirectly connected to each other, or otherwise in indirect communication with each other, with one or more intervening elements.

Methods for controlling the throughput of an electronic circuit, such as an asynchronous circuit, are provided. The throughput of the electronic circuit may be automatically determined and compared with a predetermined threshold value. If the throughput is below the threshold value, a measure boosting the throughput may be automatically carried out. If, on the other hand, the throughput is above the threshold value, a measure lowering the throughput may be automatically carried out.

The throughput of the electronic circuit consequently may be controlled in such a way that it follows, matches, or otherwise depends on, the predetermined threshold value. Therefore, the throughput of the electronic circuit may be adjusted as desired by appropriate selection of the predetermined threshold value.

Asynchronous circuits do not require a clock signal that fundamentally contributes to power consumption precisely in the case of a complex electronic circuit, such as a baseband controller. Asynchronous circuits also typically operate as quickly as possible according to their current boundary conditions since they are not bound to a clock cycle.

According to some illustrative embodiments, a boundary condition of the electronic circuit is changed in such a way that the throughput increases in response to detecting that the throughput is below the threshold value, and is further changed in such a way that the throughput is reduced in response to detecting that the throughput is above the threshold value. This boundary condition may be, for instance, a supply voltage of the circuit, a current supplied to the circuit or an operating temperature of the circuit.

The boundary conditions that are typically experienced by and relevant to an electronic circuit, such as the quality of the production method of the circuit, operating temperature of the circuit or supply voltage of the circuit, affect the speed at which the circuit operates and thereby affect the throughput. It is therefore possible for example to increase the throughput of the electronic circuit by increasing the supply voltage of the circuit or to lower the throughput of the electronic circuit by lowering the supply voltage of the circuit.

It is further possible to lower the throughput of the electronic circuit by reducing a current flow into the electronic circuit or to increase the throughput of the electronic circuit by increasing the current flow into the electronic circuit.

The throughput of the electronic circuit can in general also be increased by lowering the operating temperature while an increase in operating temperature leads to a reduction in throughput.

According to some illustrative embodiments, the throughput of the circuit is determined by instructions or operations, which are carried out by the circuit per unit of time, being counted over this unit of time, for example using a counter. A flag for example, which has a specific value if an operation of the electronic circuit has finished, can in the process be evaluated. In other words, the frequency with which this flag has this specific value per unit of time is determined or counted, wherein a frequency determined thereby per unit of time then indicates the actual throughput of the circuit.

According to further illustrative embodiments, the predetermined threshold value is generated by a counter which counts clock pulses of a reference clock.

As the threshold value is generated as a function of a reference clock, the throughput of the electronic circuit can be adjusted to this reference clock or controlled by this reference clock.

In some illustrative embodiments, the throughput and the threshold value are compared only at specific times. Two of these successive times are separated by a specific period which, for example, can be a multiple of the clock period of the reference clock and/or can depend on an operating mode of the circuit. The measures that change the throughput are then also only implemented at these times and/or in response to throughput sampling taken at these times.

Because the measures that change the throughput may also consume energy, it may be desirable to carry out these throughput measuring and/or changing measures on an infrequent basis. A compromise may be made in this case, however, because a measure that lowers the throughput may, in turn, lead to a reduction in energy consumption. It should be further considered that it may be undesirable for the throughput of the electronic circuit to arbitrarily differ from the predetermined threshold value, because in some cases other circuits that cooperate with the electronic circuit may have problems interacting with the electronic circuit. This may be another reason for implementing the measures that change the throughput on a relatively infrequent basis.

With certain operating modes, for example a standby mode in the case of a mobile phone, in which no call is made with the phone, a large throughput is not typical, for which reason the reference clock can be lowered, whereby power consumption of the mobile phone (the electronic circuit) is reduced.

According to some illustrative embodiments, a throughput controller for an electronic circuit comprises a first device for determining a throughput of the electronic circuit, a comparison device for comparing the throughput with a predetermined threshold value, and a second device for carrying out a measure to change the throughput of the circuit. In response to the comparison device detecting that the throughput is below the threshold value, the throughput controller activates the second device in such a way that the second device carries out a measure which increases the throughput of the circuit. In response to the comparison device detecting that the throughput is above the threshold value, the throughput controller controls the second device in such a way that the second device carries out a measure which lowers the throughput of the circuit.

By controlling the throughput of the electronic circuit, the electronic circuit can also be used if specific performance requirements, for example a number of operations that are to be executed per unit of time (such as measured in units of MIPS or MCPS), are to be met. In this way, the throughput of the electronic circuit may be controlled very precisely, and so it may not be necessary to adjust for example the supply voltage of the electronic circuit so as to be higher than for the throughput required by the circuit, which would otherwise lead to excessive energy consumption by the electronic circuit. Rather, the supply voltage may be adjusted more closely to the minimum supply voltage value which is required so the electronic circuit can perform the required throughput. The electronic circuit therefore may be adjusted more closely to consuming only that ideal amount of energy which is necessary to achieve the required throughput.

Such throughput adjustment may be particularly suitable for use in portable electronic devices which have only a limited amount of energy available to them since they are operated for example with a battery or accumulator. However, throughput adjustment may also be used in non-portable electronic devices to control the throughput of electronic circuits in order, for example, to minimize energy consumption by the electronic circuits controlled in this way.

A particular illustrative embodiment is illustrated in the single figure, and will be described in detail hereinafter.

The single figure shows an illustrative embodiment of a circuit 1, which may be implemented as a semiconductor device or in any other manner. The circuit 1 in this example comprises an asynchronous circuit 2 and a throughput controller 10 which controls the asynchronous circuit 2. Data is input into the asynchronous circuit 2 via a data input 11, wherein the asynchronous circuit 2 is informed by a request signal 14 if the data at the data input 11 should be processed by the asynchronous circuit 2. If the asynchronous circuit 2 has processed this data within the framework of an operation of the asynchronous circuit 2, corresponding data can be retrieved or read at a data output 12 of the asynchronous circuit 2. The fact that data can be retrieved at the data output 12 or that an operation of the asynchronous circuit 2 has finished is indicated by the asynchronous circuit 2 with the aid of a termination signal 13 (ready signal). This ready signal 13 has a value that depends on whether the data at the data output 12 is valid. For example, the ready signal 13 may have a binary value of 1 if the data at the data output 12 is valid, otherwise it may have a binary value of 0 (or vice-versa)

The ready signal 13 is supplied to a throughput counter 3 of the throughput controller 10 which counts the rising (or falling) edges of the ready signal 13 and therewith a frequency with which the asynchronous circuit 2 inputs valid data at its data output 12 following termination of an operation. This frequency of the number of rising (or falling) edges of the ready signal 13 corresponds to a number of operations which the asynchronous circuit 2 has carried out. Other features of the ready signal 13 may alternatively be counted. An output 19 of the throughput counter 3 thereby indicates a number of operations which the asynchronous circuit 2 has carried out since the start of counting or since a time at which the throughput counter 3 was reset.

A reference clock 15 is supplied to a reference counter 6 of the throughput controller 10. A reference count can be read off at the output 20 of the reference counter 6. The reference count indicates a number of clock pulses of the reference clock 15 which have accumulated since the start of counting or since a time at which the reference counter 6 was reset. The output 19 of the throughput counter 3 and the output 20 of the reference counter 6 are connected at the input side to a comparator 4 of the throughput controller 10. This comparator 4 is triggered via a frequency divider 7 of the throughput controller 10. At the input side, the reference clock 15 is supplied to this frequency divider 7, so the frequency divider 7 triggers the comparator 4 with each Nth reference clock pulse, wherein N is a natural number.

If the comparator 4 is triggered by the frequency divider 7, the comparator 4 compares the two counts 19, 20 at the input side with each other. If the throughput count 19 is greater than the reference count 20, the comparator signals to a voltage regulator 5 of the throughput controller 10 that a supply voltage V_{DD}, with which the asynchronous circuit 2 is supplied, should be lowered. If, on the other hand, the reference count 20 is greater than the throughput count 19, the comparator 4 signals to the voltage regulator 5 that the supply voltage V_{DD} should be raised.

The throughput controller 10 shown in the single figure thus controls the throughput of the asynchronous circuit 2 as a function of the reference clock 15. The supply voltage V_{DD} of the asynchronous circuit 2 is in the process regulated by the throughput controller 10 in such a way that the number of operations carried out by the asynchronous circuit 2 matches or otherwise depends on the number of clock pulses of the reference clock 15 within this time unit. By changing the frequency of the reference clock accordingly, the throughput of the asynchronous circuit 2 can also be changed or adapted accordingly.

To control how frequently the adjustment of the supply voltage V_{DD} is carried out, the comparator 4 is triggered by the frequency divider 7, the frequency divider respectively triggering the comparator 4 if it has received N clock pulses of the reference clock 15 at the input side. Since in this example a period which elapses until N clock pulses of the reference clock 15 are received by the frequency divider 7 is approximately equal to a period which elapses until the asynchronous circuit 2 carries out N operations, the supply voltage V_{DD} of the asynchronous circuit 2 is in each case adjusted after a period that the asynchronous circuit 2 takes to perform N operations.

There are various possibilities for resetting the throughput counter 3 and the reference counter 6. On the one hand the two counters 3, 6 can be reset after each comparison operation in that they are, for example, accordingly activated either by the comparator 4 or by the frequency divider 7. Furthermore the two counters 3, 6 can be reset after M comparison operations respectively, wherein M is a natural number. A further possibility is that the two counters 3, 6, are each reset as soon as one of them overruns. In each case it may be desirable that the two counters 3, 6 be reset at the same time.

1. A method, comprising:
determining a throughput of a circuit;
comparing the throughput to a predetermined value; and
controlling the circuit so as to adjust the throughput in a manner that depends upon an outcome of the comparison.

2. The method of claim 1, wherein the electronic circuit is an asynchronous circuit.

3. The method of claim 1, wherein controlling comprises changing an operating condition of the circuit.

4. The method of claim 3, wherein the operating condition comprises an operating condition selected from at least one of the following: a supply voltage of the circuit and a current supplied to the circuit.

5. The method of claim 3, wherein the operating condition comprises an operating temperature of the circuit.

6. The method of claim 1, wherein controlling comprises adjusting the throughput to be higher in response to the throughput being lower than the predetermined value.

7. The method of claim 1, wherein controlling comprises adjusting the throughput to be lower in response to the throughput being higher than the predetermined value.

8. The method of claim 1, wherein determining comprises counting a number of operations carried out by the circuit per unit of time.

9. The method of claim 1, wherein the predetermined value depends on an output of a counter configured to count clock pulses of a reference clock.

10. The method of claim 9, wherein the circuit is configured to operate in a plurality of modes, and a frequency of the reference clock depends on in which mode the circuit is operating.

11. The method of claim 1, wherein comparing is performed repeatedly at times separated by a fixed period.

12. Method according to claim 11, wherein the circuit is configured to operate in a plurality of modes, and the period depends on in which operating mode the circuit is operating.

13. An apparatus, comprising:
means for determining a throughput of a circuit;
means for comparing the throughput to a predetermined value; and
means for controlling the circuit so as to adjust the throughput in a manner depending upon the comparison.

14. An apparatus for controlling a throughput of a first circuit, comprising:
a second circuit configured to determine a throughput of a circuit;
a third circuit configured to compare the throughput to a predetermined value; and
a fourth circuit configured to control the first circuit so as to adjust the throughput in a manner that depends upon an outcome of the comparison.

15. The apparatus of claim 14, wherein the fourth circuit comprises a voltage regulator configured to regulate a supply voltage of the first circuit by selectively increasing and decreasing the supply voltage depending upon the outcome of the comparison.

16. The apparatus of claim 14, wherein the second circuit comprises a counter configured to count occurrences of a feature in a signal of the first circuit, and the second circuit is configured to determine the throughput based on the count of the occurrences.

17. An apparatus for controlling a throughput of a circuit, comprising:
a first counter configured to count occurrences of a feature in a signal of the circuit;
a second counter configured to count occurrences of a feature in a reference clock signal;
a comparator configured to compare counts generated by the first and second counters; and
a regulation unit configured to adjust an operating condition of the circuit based on an output of the comparator.

18. The apparatus of claim 17, wherein the operating condition is a supply voltage of the circuit.

19. The apparatus of claim 17, wherein the operating condition is a supply current provided to the circuit.

20. The apparatus of claim 17, wherein the operating condition is a temperature of the circuit.

21. The apparatus of claim 17, wherein the feature of the signal of the circuit is one of a falling edge and a rising edge of the signal of the circuit.

22. An apparatus, comprising:
a first circuit configured to generate a first signal;
a second circuit configured to receive the first signal and a periodic second signal and to generate a third signal based on a frequency of the first signal and a frequency of the second signal; and
a third circuit configured to adjust a throughput of the first circuit based upon the third signal.

23. The apparatus of claim 22, wherein the frequency of the second signal depends upon an operating mode of the first circuit.

24. The apparatus of claim 23, wherein the third circuit comprises a voltage regulator configured to provide the first circuit with a supply voltage, and wherein the third circuit is configured to control the voltage regulator to adjust the supply voltage depending upon the third signal.

25. The apparatus of claim 24, wherein the third circuit is configured to control the voltage regulator to adjust the voltage regulator to increase the supply voltage in response to the frequency of the first signal being lower than the frequency of the second signal, and to adjust the voltage regulator to decrease the supply voltage in response to the frequency of the first signal being higher than the frequency of the second signal.
